(19) United States
(12) Patent Application Publication
(10) Pub. No.: US 2011/0221398 A1
(43) Pub. Date: Sep. 15, 2011

(54) Impedence Balancer

(75) Inventor: Robert R. Ferber, JR., Woodside, CA (US)

(73) Assignee: Electronvault, Inc.

(21) Appl. No.: 12/724,410

(22) Filed: Mar. 15, 2010

(51) Int. Cl. H02J 7/00; H02M 3/06

(52) U.S. Cl. 320/166; 307/109

(57) ABSTRACT

An impedance balancer for power cell balancing using changes in impedance is provided. The apparatus may include a rail capacitor that is switchably connected to a first capacitor and switchably connected to a second capacitor. The first capacitor may also be switchably connected to a first power cell and the second capacitor may also switchably connected to a second power cell. Via controllable switches, the first and second capacitors may shuttle energy between the power cells through the rail capacitor. Additional and related methods and apparatuses are also provided.

### CROSS-REFERENCE TO RELATED APPLICATIONS

This application is related to application Ser. Nos. 12/XXX,XXX (titled “Modular Interconnection System”), Ser. No. 12/XXX,XXX (titled “Variable Energy System”), and Ser. No. 12/XXX,XXX (titled “Power Cell Array Receiver”), each filed on Mar. 15, 2010, and each of which are incorporated herein by reference in their entirety.

### TECHNICAL FIELD

Embodiments of the present invention relate generally to multi-cell energy systems, and, more particularly, balancing and monitoring apparatus and methods for cells within an energy storage or generation system.

### BACKGROUND

Power storage and generation technologies are rapidly evolving as consumers increase their demand for energy solutions that are both convenient and environmentally-friendly. Energy systems, which may be, for example, energy storage systems and energy generation systems, often include a number of smaller cells, such as rechargeable battery cells, that are electrically connected together. For a variety of reasons, the individual cells and/or parallel groups of cells within an energy system can sink or source current (charge or discharge in the case of batteries) at different rates resulting in imbalances between the cells.

### BRIEF SUMMARY

Example embodiments of the present invention include methods and apparatuses for balancing impedance across a number of power cells or parallel groups of power cells in an energy system, such as, for example, an energy storage system or an energy generation system. In some example embodiments, capacitors can be utilized to shuttle energy between power cells of an energy system to balance energy stored in the power cells or parallel groups of power cells. Capacitors associated with each power cell or parallel group of power cells may be configured to operate as flying capacitors to shuttle charge to and from a rail capacitor. The rail capacitor can be implemented to shuttle charge between flying capacitors and ultimately between power cells for balancing. According to some example embodiments, an impedance balancer may be a sensorless device, because the switching performed to shuttle charge via the capacitors is not impacted by cell voltage or resistance spreads, Ohmic sag or boost of the cells, or the like. The impedance balancer can operate regardless of the loading condition of the energy system (e.g., under a heavy load, under a light load, or under no load). In addition, the voltage of the rail capacitor may also be monitored to determine an aggregate status of the power cells of an energy system.

### BRIEF DESCRIPTION OF THE DRAWING(S)

Having thus described the invention in general terms, reference will now be made to the accompanying drawings, which are not necessarily drawn to scale, and wherein:

FIG. 1 is an illustration of an example electrical configuration of power cells according to various example embodiments;

FIG. 2 illustrates an example impedance balancer connected to two power cells according to various example embodiments;

FIG. 3 illustrates an example method for performing power cell balancing according to various example embodiments;

FIG. 4 illustrates another example impedance balancer according to various example embodiments;

FIG. 5 is a graph of control signal waveforms according to various example embodiments;

FIG. 6 is a graph of charging a flying capacitor and a rail capacitor according to various example embodiments;

FIG. 7a is a graph of an alternative control signal waveform according to various example embodiments

FIG. 7b illustrates a schematic of a circuit that includes a control signal waveform generator for generating the waveform of FIG. 7a according to various example embodiments;

FIG. 8 illustrates an example energy management system monitor connected as a component of a impedance balancer according to various example embodiments; and

FIG. 9 illustrates another example impedance balancer with an example energy management system monitor according to various example embodiments.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Like reference numerals refer to like elements throughout.

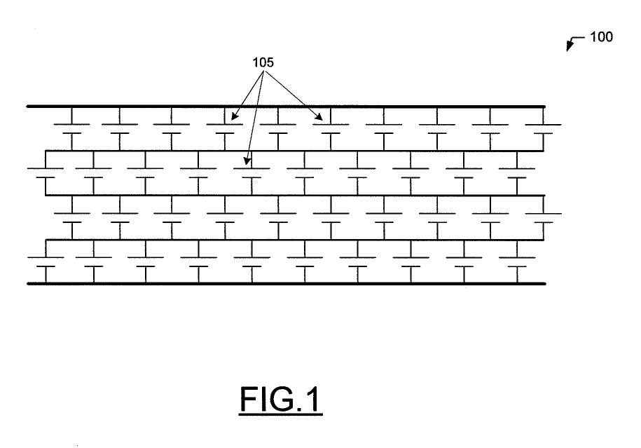

FIG. 1 illustrates an example electrical configuration 100 of power cells 105 that can be used within an energy system for powering loads in a variety of settings. For example, vehicles, including cars, trucks, bikes, and the like, may be powered by an energy system power cell configuration of this type. Energy storage systems may also be utilized in coordination with smart grid technologies to perform, for example, peak shaving, backup power, and the like. The voltage and current capacity of an energy system may be determined by the manner in which the power cells of the system are electrically connected together. In this regard, power cells may be connected as a series of parallel groups. A power cell may be any type of apparatus that outputs or sinks power. According to various example embodiments, power cells of any common voltage or chemistry may be balanced via the example impedance balancers described herein. Power cells can include, for example, electrochemical or electrostatic cells, which may include batteries, such as lithium-ion, lead-acid, and metal-air batteries, capacitors (e.g., ultracapacitors and supercapacitors), fuel cells, photovoltaic cells, Peltier junction devices, piezoelectric cells, thermopile devices, solid state conversion cells, other hybrids of electrochemical and electrostatic cells, or the like, and combinations thereof. Different applications for energy systems comprising a number of power cells may require different voltages and current capacities, thereby requiring different electrical configurations of power cells. The example electrical configuration 100 is a 4s10p configuration, which indicates that 4 series connected parallel groups of 10 power cells make up the configuration.

Power cells within an energy system can be described as having a particular state of charge. The state of charge can be defined as a ratio of remaining energy capacity to the energy capacity available in a fully charged state for a power cell. The state of charge for a power cell changes when, for example, the power cell is placed under a load or when the cell is being recharged. Various example embodiments described herein operate to balance the state of charge through impedance balancing. In the case of power cells that are generative instead of storage, such as solar cells or Peltier junction devices, there is no state of charge. Instead, these power generative cells have a power output level that in some way resembles a state of charge, in that it can be defined as the ratio of the instantaneous output power to the maximum possible (or maximum rated, as appropriate) output power. “Power output level” as just defined can be treated as lexically interchangeable with “state of charge”, as appropriate to the type of power cells in question.

For a variety of reasons, cells within an energy system may operate differently. Due to various factors including age, exposure to high temperatures, manufacturing flaws, or the like, a power cell may not be able to store and deliver the same amount of energy as other cells within a power system. Often, the changes that occur within a cell that occur as a result of, for example, aging, cause the internal impedance and energy storage capability or power production capability of the cells to change. These differences in impedance, which can be temperature dependent, can cause some cells to output more power than others thereby generating hotspots within the energy system, which can be detrimental to cell life and lead to increased imbalance. If the system has more than one parallel group of power cells in series, this imbalance can appear as a difference in each parallel group in the series string to sink or source current, resulting in a constriction in the current path, possibly leading to elements of the lowest current capability parallel group to be driven over their actual instantaneous current capabilities (or outside of their voltage normal operating limits) while all other elements of the system are within their normal operating limits. Further, if a cell becomes completely discharged, while others continue to drive the load, the discharged cell may operate unpredictably and can, for example, become an open circuit, a short circuit, change polarity (which can result in the cell being destroyed), or the like. Such problems can detrimentally effect the overall operation of an energy system and shorten the life and current capacity of some or all of the cells within the system.

To avoid the issues that can arise as a result of power cell imbalance, the power cells, such as power cells 105, may be balanced relative to each other, on an individual power cell basis, or balancing may performed with respect to parallel groups (such as amongst the four parallel groups of electrical configuration 100). One option for balancing power cells or parallel groups of power cells, could be to simply connect the cells in parallel. By connecting the power cells in parallel the impedances of the power cells can be balanced and issues associated with imbalance can be avoided. However, this would undesirably change the electrical configuration of the energy system and the voltage and current capacity characteristics.

According to various example embodiments, capacitors that are switchably connected in parallel with the cells or parallel groups of cells can be utilized to perform impedance balancing without changing the electrical configuration of the cells. To implement cell balancing with respect to differences in impedance between the cells, capacitors may be utilized to shuttle charge or energy between the cells or parallel groups of cells. The charge can be shuttled from power cells or parallel groups that have more charge or which are sinking or sourcing more current, to power cells or parallel groups that have less charge or which are sinking or sourcing less current. In this manner, balancing between the cells can be achieved. By shuttling charge between the cells, the operation of the cells can be normalized, which can minimize thermogenesis and the premature failure of power cells due to non-uniform heating. Further, the shuttling of charge reallocates the energy distribution within the power cells without creating substantial increases in heat generation. Since the impedance of the power cells can be temperature dependent, by limiting the amount of heat generated through cell balancing, the need to perform further balancing can also be reduced because heat is not introduced that continues to cause changes to the impedance of the power cells. According to various example embodiments, the capacitors can be used to balance the impedance of the cells and shuttle charge or energy, while the energy system is being charged, while the energy system is supplying power to a load or sinking power from a source, or while an energy system is under no load. In this regard, example embodiments can be implemented to perform balancing during, for example, charging of the power cells regardless of whether a parallel or series charging scheme is utilized. Further, impedance balancing according to various example embodiments can be performed continuously, regardless of the load or charge conditions of the energy system. In some example embodiments, impedance balancing may be perform between entire energy systems, which may comprise a number of series connected parallel groups of power cells.

Various example embodiments of the present invention utilize capacitors or other charge storage devices to shuttle energy between power cells of an energy system to balance the charge stored in, or current generated by or sunk into the power cells by balancing the impedance. Through the use of capacitors that parallel the terminals of power cell or parallel a group of power cells, the power cells or parallel groups of power cells can be thought of as being connected in parallel during a balancing operation to bring the two cells or parallel groups of cells to a common impedance. However, through the use of switchably connected capacitors, the cells of parallel groups of cell are not actually connected in parallel during balancing. As a result, charge that flows from one power cell to the capacitor can be delivered to another power cell. The capacitor can therefore be used to either provide charge to a power cell at a lower potential or receive charge from a power cell having a higher potential. Based on this concept, a charged or discharged capacitor can, through the use of switches, move charge from a first power cell through a rail capacitor to another power cell to perform a balancing operation. Operation in this manner can, according to some example embodiments, provide for application flexibility because power cells having any type of cell chemistry and any rated voltage may be balanced.

Additionally, with respect to charging, due to the shuttling of charge from a highly charged cell or parallel group to a lower charged cell or parallel group, according to some example embodiments, cell charges may be connected to, for example, a single cell or a single parallel group. Via impedance balancing through capacitors, as described herein, charge from the cell or parallel group that is being charged may be redistributed throughout the cells of an energy system.

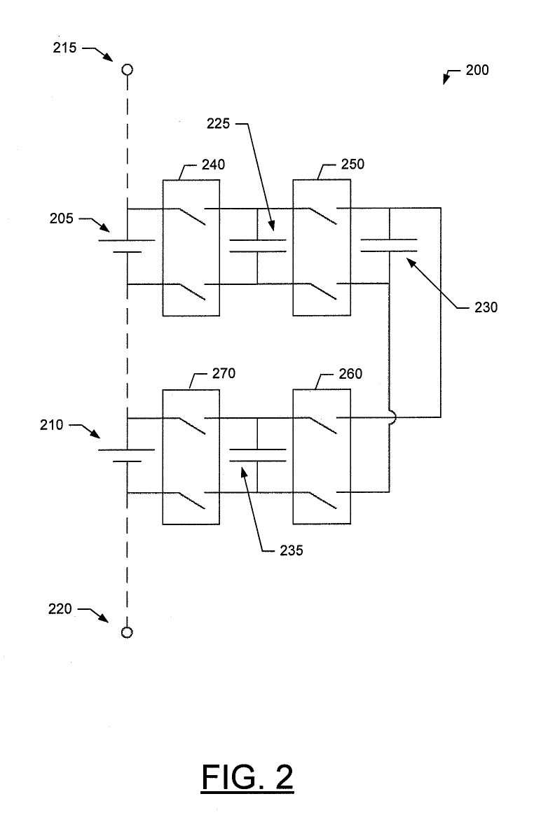

FIG. 2 illustrates an example impedance balancer 200 connected to two power cells 205 and 210. For explanation purposes, the impedance balancer 200 is described with respect to balancing between the two cells 205 and 210. However, the impedance balancer 200 may be scaled up, by adding flying capacitors, switches, and circuitry to drive the switches, to balance any number of cells or parallel groups of cells. The impedance balancer 200 may include flying capacitors 225 and 235, a rail capacitor 230, switch sets 240, 250, 260, and 270, and energy system terminals 215 and 220.

Flying capacitors 225 and 235 may be referred to as “flying” as a result of being switchably connected either to a respective power cell 205, 210 or the rail capacitor 230 to shuttle energy between the respective power cell 205, 210 and the rail capacitor 230. In some example embodiments, the charge carrying capacity of the flying capacitors may be selected based on the rated current of the power cell so as to limit the maximum current flow between the shuttle capacitors and the power cell. For example, for a 5 ampere rated power cell, a 20 microfarad capacitor can be selected for the flying capacitor for a given switch resistance value.

The rail capacitor 230 may be referred to as such, because the rail capacitor 230 is preferably switchably connected to each of the flying capacitors 225, 235. According to some example embodiments, the rail capacitor can be sized to have a larger charge carrying capacity than the flying capacitors. For example, if the flying capacitors are 20 microfarads, the rail capacitor may be 100 microfarads.

The switch sets 240, 250, 260, and 270 may be any type of devices that can be controlled to generate and break an electrical connection. Each of switch sets 240, 250, 260 and 270 can be configured to operate as a two switch set where each of the switches operate substantially in unison to generate or break electrical connections. In this regard, the switch sets 240, 250, 260, and 270 may be configured to operate as double-pole, single throw switches. According to some example embodiments, each switch within a switch set can be a field-effect transistor that is controlled via a control signal to a gate terminal of the field-effect transistor.

Referring again to apparatus 200, switch set 240 is connected such that when switch set 240 is closed (i.e., generating an electrical connection), terminals of the flying capacitor 225 are electrically connected across the terminals of the power cell 205, and when the switch set 240 is open (i.e., breaking an electrical connection), the flying capacitor 225 is not connected to the power cell 205 and is electrically isolated from power cell 205. Switch set 250 is connected such that when switch set 250 is closed, terminals of the flying capacitor 225 are electrically connected across the terminals of the rail capacitor 230, and when the switch set 250 is open, the flying capacitor 225 is not electrically connected to the rail capacitor 230 and is electrically isolated from rail capacitor 230. Similarly, switch set 260 is connected such that when switch set 260 is closed, terminals of the flying capacitor 235 are electrically connected across the terminals of the rail capacitor 230, and when the switch set 260 is open, the flying capacitor 235 is not electrically connected to the rail capacitor 230 and is electrically isolated from rail capacitor 230. Switch set 270 is connected such that when switch set 270 is closed, terminals of the flying capacitor 235 are electrically connected across the terminals of the power cell 210, and when the switch set 270 is open, the flying capacitor 235 is not connected to the power cell 210 and is electrically isolated from power cell 210.

Each of the switch sets 240, 250, 260, and 270 may be controlled by control signals provided by, for example, control signal circuitry. According to some example embodiments, each switch within the switch sets may be controllable by a respective control signal. The control signals are preferably configured to coordinate the operation of the switches to carry out balancing operations.

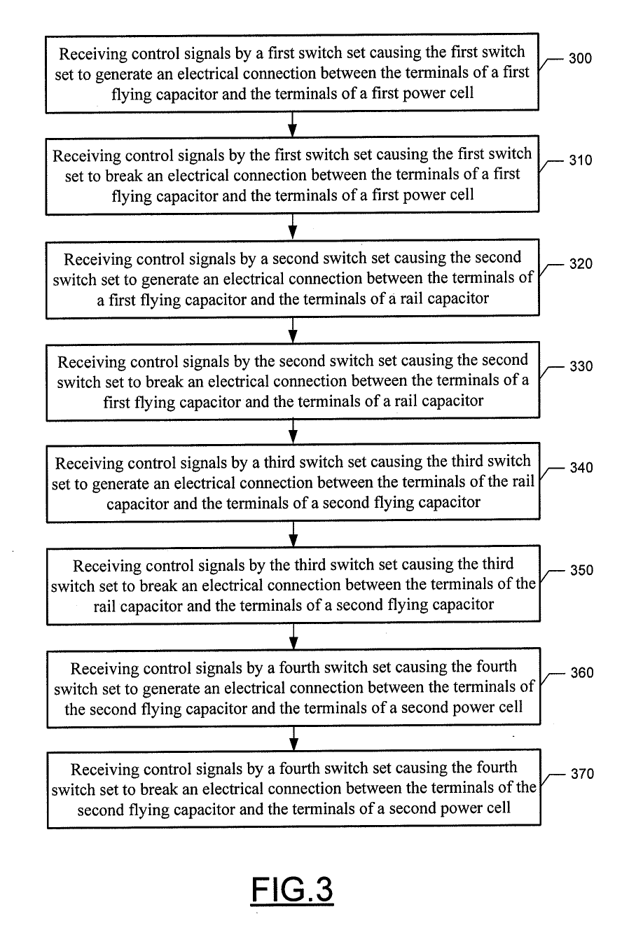

FIG. 3 illustrates an example method for performing cell balancing that can be implemented, for example, by the apparatus 200 via control signals that cause operation of the switches 240, 250, 260, and 270. In this regard, at 300, control signals can be received by switch set 240 (first switch set) causing switch set 240 to generate an electrical connection between the terminals of flying capacitor 225 (first flying capacitor) and the terminals of the power cell 205 (first power cell) to charge or discharge the flying capacitor 225 across the terminals of the power cell 205. At 310, control signals can be received by switch set 240 causing switch set 240 to break an electrical connection between the terminals of flying capacitor 225 and the terminals of the power cell 205 to discontinue charging or discharging of the flying capacitor 225 across the terminals of the power cell 205.

At 320, control signals can be received by switch set 250 (second switch set) causing switch set 250 to generate an electrical connection between the terminals of the flying capacitor 225 and the terminals of the rail capacitor 230 to charge or discharge the flying capacitor 225 across the terminals of the rail capacitor 230. At 330, control signals can be received by switch set 250 causing switch set 250 to break an electrical connection between the terminals of the flying capacitor 225 and the terminals of the rail capacitor 230 to discontinue charging or discharging of the flying capacitor 225 across the terminals of the rail capacitor 230.

At 340, control signals can be received by switch set 260 (third switch set) causing switch set 260 to generate an electrical connection between the terminals of the flying capacitor 235 (second flying capacitor) and the terminals of the rail capacitor 230 to charge or discharge the flying capacitor 235 across the terminals of the rail capacitor 230. At 350, control signals can be received by switch set 260 causing switch set 260 to break an electrical connection between the terminals of the flying capacitor 235 and the terminals of the rail capacitor 230 to discontinue charging or discharging of the flying capacitor 235 across the terminals of the rail capacitor 230.

At 360, control signals can be received by switch set 270 (fourth switch set) causing switch set 270 to generate an electrical connection between the terminals of the flying capacitor 235 and the terminals of the power cell 210 (second power cell) to charge or discharge the flying capacitor 235 across the terminals of the power cell 210. At 370, control signals can be received by switch set 270 causing switch set 270 to break an electrical connection between the terminals of the flying capacitor 235 and the terminals of the power cell 210 to discontinue charging or discharging the flying capacitor 235 across the terminals of the power cell 210.

Via the example method of FIG. 3, energy can be moved from power cell 205 to power cell 210 to balance the energy between the cells. According to some example embodiments, by reversing the order of operations of the example method of FIG. 3, energy can be moved from power 210 to power cell 205. Further, according to some example embodiments, the operations 300 through 370 may be scaled to perform balancing between any number of cells via use of the rail capacitor. According to some example embodiments, the control signals for controlling the switch sets 240 and 250 can be configured such that switch sets 240 and 250 are not simultaneously closed, to avoid electrically connecting the rail capacitor across the terminals of the power cell 205. Similarly, according to some example embodiments, the control signals for controlling the switch sets 260 and 270 can be configured such that switch sets 260 and 270 are also not simultaneously closed.

Further, according to some example embodiments, the operation of a given switch of a particular switch set may be based on a frequency of a control signal for controlling that switch. Switches within a common set can be operated with a control signal having the same or similar frequency to facilitate simultaneous operation of the switches within the set. Additionally, according to some example embodiments, the frequencies and waveforms of the control signals can be defined in a manner that avoids the simultaneous closure of switch set 240 with switch set 250, or switch set 260 with switch set 270.

According to some example embodiments, the frequency of operation of the switch sets can be increased or decreased to have different effects on the balancing. For example, if the frequency is increased, the cells of the energy system can be balanced more rapidly to achieve a lower average imbalance over a period of time. Increasing the frequency of balancing may be desired when an energy system is outputting high currents, which can tend to cause imbalance between the cells at a relatively more rapid pace. On the other hand, for example, the frequency of operation may be decreased to slow the balancing of the cells. Slowing the balancing operations may be utilized when then power storages system is outputting low current or no current, which can tend to cause imbalance between cells at a relatively slower pace. Decreasing the frequency during low or no current output can also result in power savings by reducing the energy used for balancing operations. According to some example embodiments, an ammeter or other current sensing device can be included in an example balancing apparatus that measures the output current for the power system, and modifies the frequency of operation of the switches based on the measured output current.

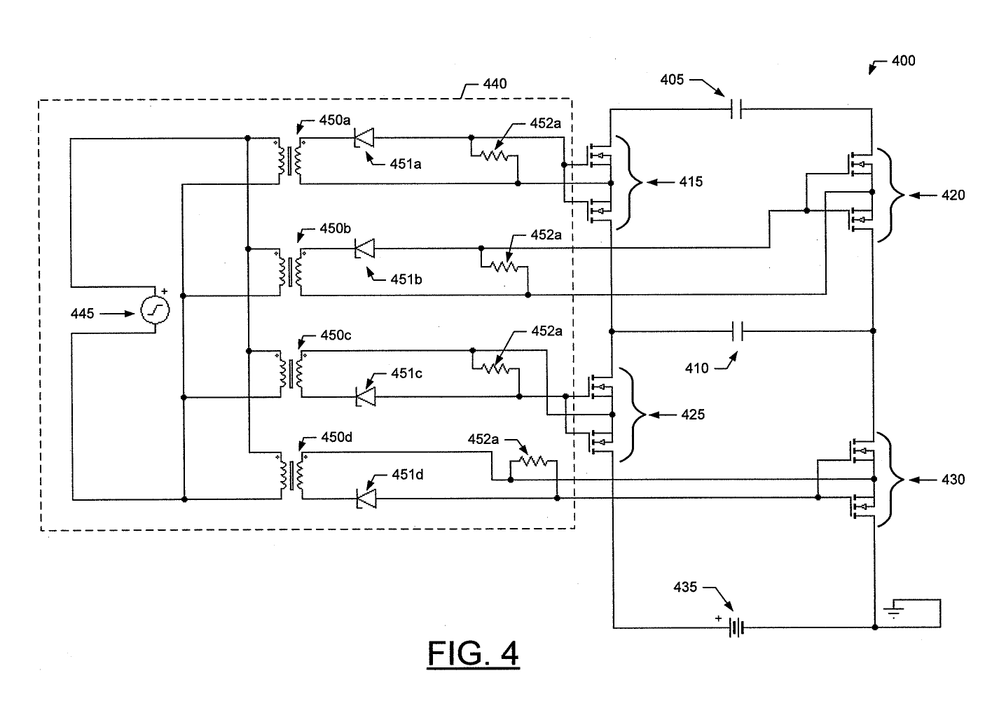

FIG. 4 illustrates another example impedance balancer 400 according to various example embodiments of the present invention. In comparison to FIG. 3, the impedance balancer 400 includes switches and a flying capacitor for interacting with a single cell. However, based on the description of FIG. 3, the concepts described with respect to FIG. 4 can be scaled for interaction with any number of power cells to perform impedance balancing.

The impedance balancer 400 of FIG. 4 includes a rail capacitor 405, a flying capacitor 410, switches 415, 420, 425, and 430, and control signal circuitry 440. The rail capacitor 405 is switchably connected to the flying capacitor 410 via the switches 415 and 420. The flying capacitor 410 is switchably connected to the power cell 435 via switches 425 and 430. As such, referencing FIG. 3, the switches 425 and 430 can correlate to the switch set 240 and switches 415 and 420 can correlate to the switch set 250. Each of switches 415, 420, 425, 430 comprise two field-effect transistors (FETs) that are source-source connected and share a common gate terminal connection to the control signal circuitry 440. In this configuration, the two FETs can operate as a single switch that can be controlled via a signal applied to the common gate connection.

The control signal circuitry 440 is preferably configured to generate a control signal for each of the switches 415, 420, 425, and 430, in accordance with various example embodiments. The signals generated by the control signal circuitry 440 can be configured to drive the gate terminals of the FETs. In this regard, each FET can be configured to generate a conductive channel (close the switch or generate an electrical connection) when a voltage applied to the gate terminal is a particular value. For example, the FETs can be configured to generate a conductive channel when the voltage applied to the gate terminal exceeds a gate threshold voltage. As such, if, for example, a sine wave is applied to the gate terminal of a FET, the FET can generate a conductive channel during the portion of the sine wave when the gate threshold voltage is exceeded. When the voltage of the sine wave falls below the gate threshold voltage, no conductive channel is formed (switch is open or break an electrical connection).

As described above, the order in which the switches 415, 420, 425, and 430 are operated to generate and break electrical connections as part of an impedance balancing operation can be configured to prevent switches 425 and 430 from being closed at the same time as switches 415 and 420. To do so, according to some example embodiments, a waveform that is received by switches 415 and 420 can be inverted or shifted 180 degrees and provided to the respective gate terminals of the FETs. In some example embodiments, an inverted or 180 degree shifted version of the same waveform can be generated by connecting opposite polarities for the control signals to switches 415 and 420 relative to the polarity used for switches 425 and 430.

The control signal circuitry 440 of FIG. 4 provides one example of an apparatus for generating control signals for the switches. The control signal circuitry can comprise a signal generator 445, transformers 450 (e.g., transformers 450a, 450b, 450c, and 450d), diodes 451 (e.g., diodes 451a, 451b, 451c, 451d), and resistors 452 (e.g., resistors 452a, 452b, 452c, and 452d). The signal generator 445 can be any type of device configured to generate a dynamically changing signal (e.g., an alternating current signal). According to some example embodiments, the signal produced by the signal generator can take the form of a sign wave, a sawtooth, a step function, or the like.

A first terminal of the signal generator 445 can be electrically connected to a respective first primary winding terminal of each of the transformers 450, and a second terminal of the signal generator 445 can be connected to a respective second primary winding terminal of each of the transformers 450. The transformers 450 and the winding ratios of the transformers 450 may be selected based on, for example, the gate threshold voltage of the FETs and the rate of change in the voltage of the signal generator. Additionally, the gate terminal of the FETs can have an internal capacitance, which the transformers 450 can be configured to store sufficient energy to exceed any energy that may be stored in the gate's internal capacitance. In this regard, the transformers can be configured to store sufficient energy to cause the FETs to generate a conductive channel. According to some example embodiments, the transformers 450 may be pulse transformers.

Additionally, the secondary terminals of the transformers can be connected to the gates of the FETs such that the polarity that is used in the connections to switches 415 and 420 is opposite to the polarity used in the connections to the switches 425 and 430. In this manner, the gate terminals of the FETs for switches 415 and 420 can receive an inverted signal relative to the signal received at the gate terminals of the FETs for switches 425 and 430.

Some example embodiments may include the resistors 452 and diodes 451, however, in some example embodiments, a impedance balancer may be constructed without the resistors 452 and diodes 451. The resistors 452 connected across the secondary terminals of the transformers 450 can operate to form a circuit current path with a current limiting voltage drop. The diodes 451 can be Zener diodes connected between the transformer terminal and the gate terminals of the FETs in a manner that impacts the waveform output by the transformer terminals to create a gap between the latest opening of a first set of switches and the earliest closing of a second set of switches. In this manner, the waveform driving the gates can be asymmetric around zero volts. In this regard, the internal capacitance of the gates of the FETs, or a shunt capacitor connected across the secondary terminals of the transformer, can discharge through the diode when, for example, a sinusoidal waveform is falling below the voltage of the charged internal capacitances o the shunt capacitor. This discharging through the diode can have the effect of flattening a portion of the waveform as the voltage of the waveform drops through, for example, zero volts.

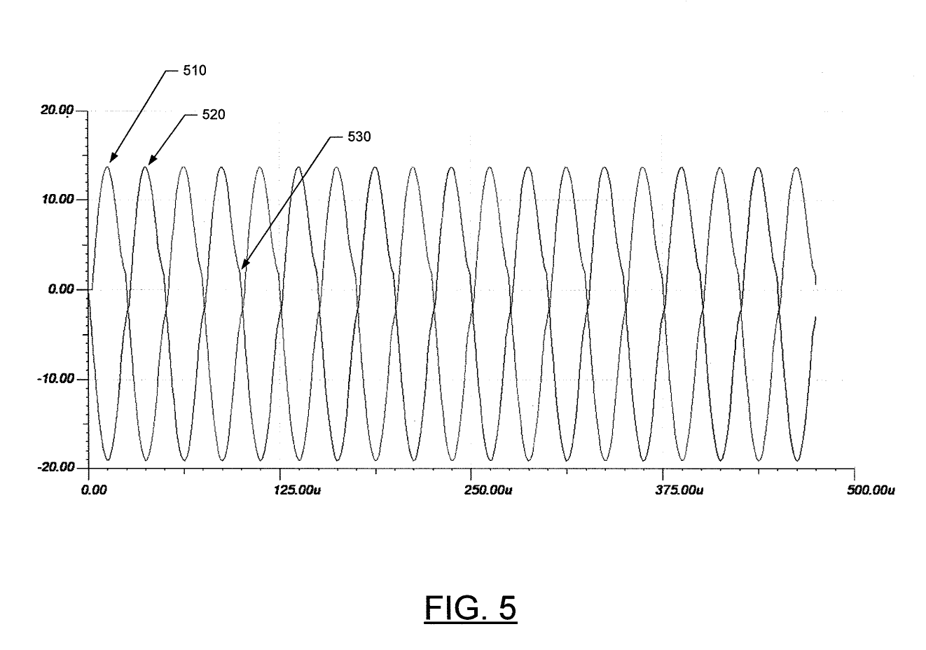

FIG. 5 is a graph of the resultant waveforms that are received at the gates terminals of the FETs in FIG. 4, given a sinusoidal source signal. The waveform 510 can drive the gate terminals of, for example, switches 415 and 420, and the waveform 520 can drive the gate terminals of, for example, switches 425 and 430. Due to the presence of a diode in the gate terminal circuit, waveforms 510 and 520 flatten, for example, at 530. This flattening as the voltage decreases creates a durational gap between the waveforms 510 and 520 at zero volts and the waveforms do not cross until approximately negative 2 volts. As a result, assuming the gate threshold voltages are a positive voltage (e.g., 0.6 volts) for the FETs, switches 415 and 420 will not be generating an electrical connection at the same time as switches 425 and 430.

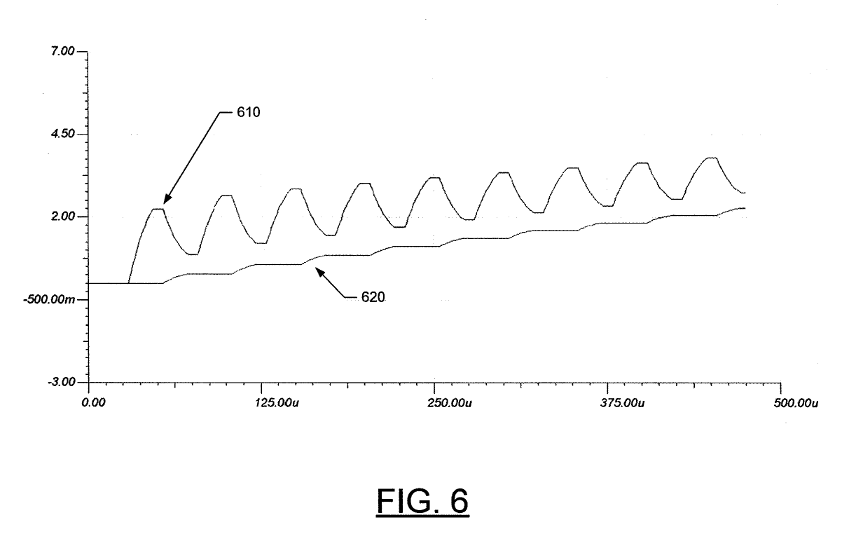

FIG. 6 is a graph 610 of flying capacitor 410 being charged across the power cell 435 based on the control signals of FIG. 5, and a graph 620 of the charging of the rail capacitor 405 via the flying capacitor 410 based on the control signal of FIG. 5. The clipped peaks and valleys of the flying capacitor charging graph 610 are a result of the durational gap when switches 415, 420, 425, and 430 are all open to facilitate a break-before-make transition from the flying capacitor 410 being connected to the power cell 435 and then to the rail capacitor 405. The flying capacitor voltage in graph 610 also indicates that the power cell voltage is slowly increasing during the process depicted in FIG. 6. The rail capacitor charge graph 620 shows that when the flying capacitor 410 is discharging, the rail capacitor 405 is being charged by the flying capacitor 410. It is noteworthy that the graph 620 shows the rail capacitor continuing to increase in charge. However, if the rail capacitor 405 were switchably connected to additional flying capacitors and associated power cells according to various example embodiments, the rail capacitor could be discharging to the other flying capacitors, thereby dropping the charge storage level of the rail capacitor.

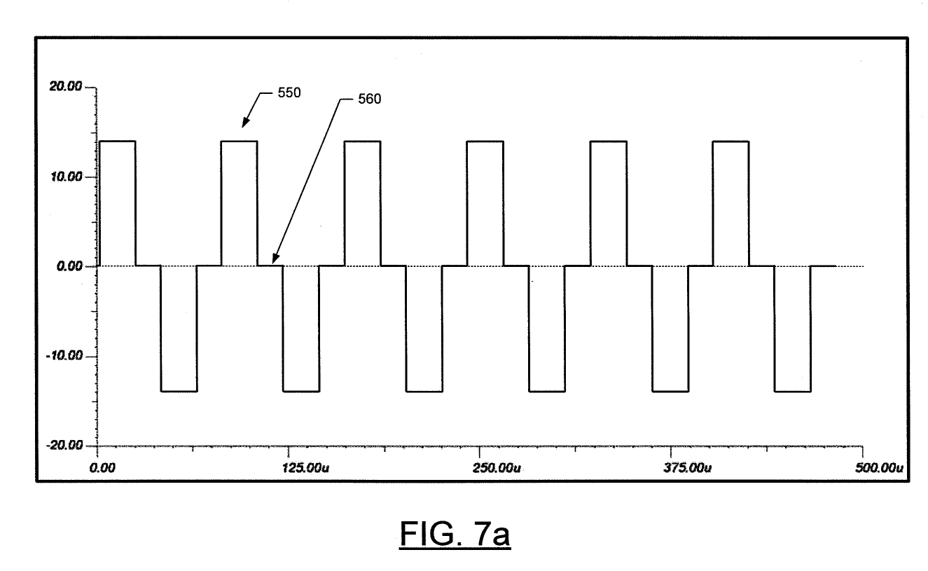

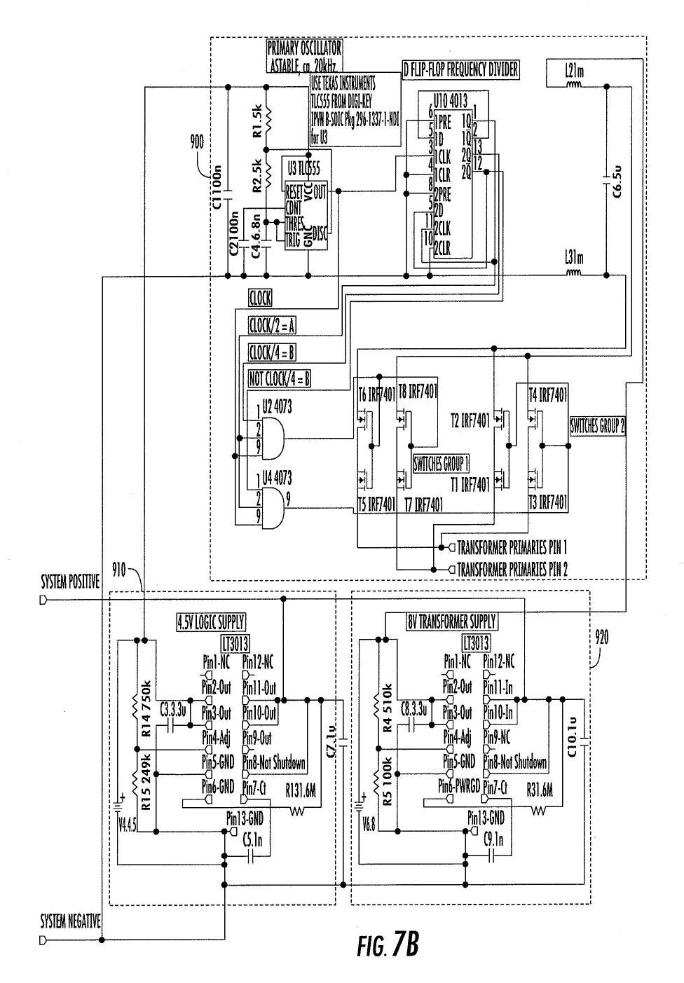

FIG. 7a illustrates a graph of an alternative control signal 550 that may be provided to the gate terminals of, for example, the FETs in FIG. 4. In this regard, control signal 550 may be provided to the gate terminals of switches 415 and 420, and the inversion of control signal 550 may be provided to the get terminals of the switches 425 and 430. The waveform 550 is defined as a 3 level step function, where, within each cycle the waveform include a period of time at a high level, a period at a zero level 560, and a period at a low level. The period at the zero level 560 may be configured such that the duration is sufficient to ensure that, for example, switches 415 and 420 are not closed at the same time as switches 425 and 430. According to some example embodiments, the waveform 550 and the inversion of the waveform 550 may be provided directly to the gate terminals of the respective switches by, for example, a signal generator configured to generate the waveform 550. In this regard, according to some example embodiments, the signal generator may include outputs where a first polarity of the outputs is connected to the gate terminals of 415 and 420 and as second and opposite polarity is connected to the gate terminals of the switches 425 and 430.

FIG. 7b illustrates an example schematic diagram for a control signal waveform generator circuit according to various example embodiments. The control signal waveform generator circuitry 900 may be configured to generate the waveform 550 of FIG. 7a. The control signal waveform generator circuitry 900 outputs to the primaries of a transformer, such as, for example, the transformers 450 of FIG. 5. In this regard, the control signal waveform generator circuitry 900 may correlate to the signal generator 445. Additionally, the circuitry 910 may be configured as one example circuit for providing a power supply to logic components. Further, the circuitry 920 may be configured as one example circuit for providing a power supply to drive the transformers.

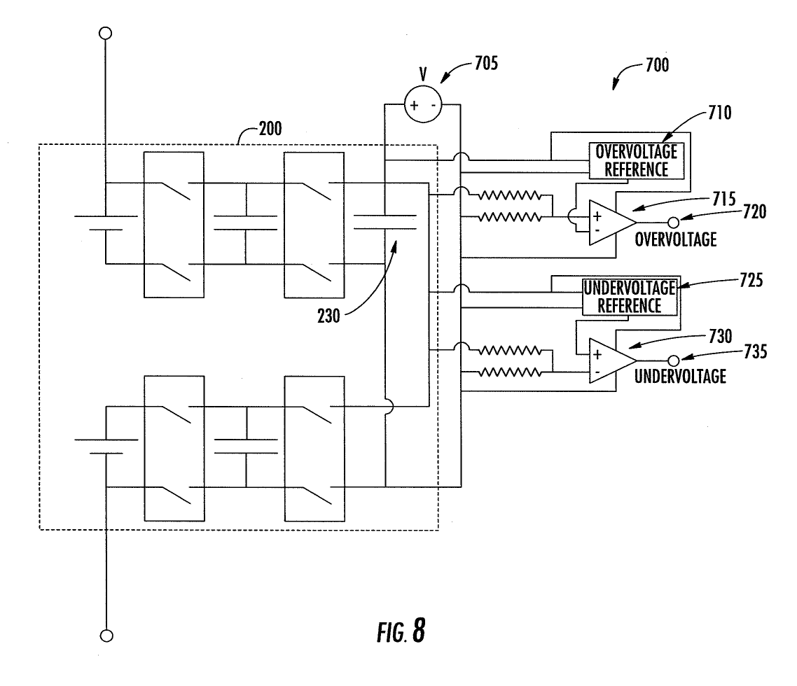

FIG. 8 illustrates a energy management system monitor 700 connected to the impedance balancer 200 of FIG. 2. The energy management system monitor 700 can be comprised of monitoring circuitry configured to monitor the voltage across the terminals of the rail capacitor 230, and use an indication of the voltage as an aggregate status indicator for the power cells of the energy system. In this regard, the monitoring circuitry can receive an indication of a voltage across the rail capacitor terminals and provide a status indicator for an energy system based on the received indication. According to various example embodiments, an indication of the rail capacitor voltage can be analyzed, for example, by a processor or analog systems and detailed information, for example the actual voltage value, may be output to a display of a user interface and used as an indication of an energy system status. In some example embodiments, reference voltages for undervoltage and overvoltage conditions can be defined, and the voltage of the rail capacitor can be compared to the references. In this regard, the monitoring circuitry can be configured to compare an indication of a voltage across the rail capacitor terminals to an overvoltage reference to determine an overvoltage status of an energy system, and compare an indication of a voltage across the rail capacitor terminals to an undervoltage reference to determine an undervoltage status of the energy system. If an overvoltage condition is identified, then, for example, an overvoltage light emitting diode (LED) can be lit. Similarly, if an undervoltage condition is identified, then, for example, and undervoltage LED can be lit.

According to some example embodiments, an energy management system monitor may be configured to consider the current aggregate average voltage of the parallel groups as indicated by the voltage across the rail capacitor, the current that the entire energy system is currently sinking or sourcing, and the impedance of the entire energy system (e.g., the entire system's dV/dI). Based on a map of a characteristic discharge curve for the given chemistry of the power cells (e.g., a map or graph of the resting voltage versus the percentage of energy extracted, or resting voltage versus the Joules in or out), the local impedance (dV/dI), and a quality estimate of the average voltage of the parallel groups making up the system (e.g., the voltage observed at the rail capacitor), Ohm's law can be used to determine a position in a “resting voltage” characteristic discharge curve. In some example embodiments, the characteristic discharge curve can be dynamically determined based on historical system data.

With the use of, for example, a processor, a voltage sensor, and a current sensor, the relationship between voltage and current can be determined and updated based on recently collected data points for voltage and current. The impedance date for the system can be derived from the voltage/current relationship. In this regard, a voltage sensor on the rail capacitor can provide the input voltage (Vrail), and a current sensor on the energy system output can provide the output current (Tout). A memory, for example a volatile memory, can store the discharge curve shape and the equation to calculate the resting voltage, which is Vrest=Vrail+Tout*Rsystem. With an analog system, a variable gain amplifier and operational amplifiers (opamp) of fixed gain can be utilized to determine the result. In this regard, the first opamp can buffer the measured rail capacitor voltage, and the second opamp can scale the current sensor data. A third opamp can take the differential of the output of the first and second opamps and provides the resting voltage estimate. The voltage signal from the current sensor can be multiplied via the variable gain amplifier, where the gain is the value of Rsystem which can be derived from an analog differentiator circuit.

Both a processor-based or analog component-based system can thus accurately provide a State of Charge within the characteristic discharge curve. This can be performed in realtime from direct measurements and a buffer of recent historic operational data points to derive the impedance and the discharge curve. The energy management system monitor may also consider impedance of the system as an indication of system health. Additionally, or alternatively, changes in the shape and position of the characteristic discharge curve can be used as indications of system health. The State of Charge, as well as the other measured and determined values may be output to a user interface (e.g., light emitting diodes, a display, or the like) or used as inputs to another system that may stores the values as data or perform further analysis.

An additional or alternative measure of energy system health can be based on the current (e.g., RMS current) that is flowing into or out of a flying capacitor between the flying capacitor and the cell or parallel group of cells, or between the flying capacitor and the rail capacitor. In a balanced system this current would be relatively small or zero. Relatively higher currents for a flying capacitor can indicate whether the associated cell or parallel group of cells is strong or weak. The values provided by current sensors connected to the flying capacitors may provide inputs to a user interface, such as a respective LEDs where the brightness of the LEDs can indicate the relative health of the associated cell or parallel group. Additionally, or alternatively, the current sensors may provide inputs to a processor that can, for example, further aggregate and analyze the values, provide indications of the values to a display, or store the values for historical analysis.

As such, the operation of the rail capacitor within a impedance balancer can also be leveraged for the purpose of also providing information about the overall health of the cells of the energy system. By monitoring the rail capacitor in this way, according to some example embodiments, only one voltage monitor is utilized for the entire energy system, thereby reducing cost and complexity.

The energy management system monitor 700 can utilize the voltage across the rail capacitor to provide a status indicator for an energy system. The energy management system monitor 700 includes an overvoltage reference 710, an overvoltage comparator 715, an overvoltage status output 720, an undervoltage reference 725, an undervoltage comparator 730, and an undervoltage status output 735.

The overvoltage reference 710 and the undervoltage reference 725 can be variable resistors, precision voltage sources, bandgap references, or other mechanisms for establishing a desired reference voltage based on the voltage provided by the reference voltage source 705. The outputs of the overvoltage reference and the undervoltage reference can be fed into the inputs of respective comparators 715 and 730. The comparators 715 and 730 can also receive an indication of the voltage across the rail capacitor 230, for example, via a resistor network. The overvoltage comparator 715 can be configured to determine if the indication of the voltage across the rail capacitor 230 is greater than the voltage provided by the overvoltage reference 710. If the indication of the voltage across the rail capacitor 230 is greater than the reference voltage, then the overvoltage status output 720 can indicate a “true” output (e.g., provide a high voltage level). If the indication of the voltage across the rail capacitor 230 is less than the reference voltage, then the overvoltage status output 720 can indicate a “false” output (e.g., provide a low voltage level). Similarly, the undervoltage comparator 730 can be configured to determine if the indication of the voltage across the rail capacitor 230 is less than the voltage provided by the undervoltage reference 725. If the indication of the voltage across the rail capacitor 230 is less than the reference voltage, then the undervoltage status output 735 can indicate a “true” output (e.g., provide a high voltage level). If the indication of the voltage across the rail capacitor 230 is less than the reference voltage, then the overvoltage status output 735 can indicate a “false” output (e.g., provide a low voltage level).

An energy management system monitor, such as, for example, the energy management system monitor 700, can be configured to operate while the energy system is supplying a load, being charged, or is dormant. Further, a energy management system monitor 700 can be configured to operate during balancing operations, such as, for example, the balancing operation described with respect to FIG. 3. In this regard, according to some example embodiments, the example method of FIG. 3 can further include receiving an indication of a voltage across the terminals of the rail capacitor, and providing a status indicator for an energy system based on the received indication. In some example embodiments, the example method of FIG. 3 can, additionally or alternatively, include comparing an indication of a voltage across the terminals of the rail capacitor to an overvoltage reference to determine an overvoltage status of an energy system, and comparing an indication of a voltage across the terminals of the rail terminals to an undervoltage reference to determine an undervoltage status of the energy system.

Additionally, according to some example embodiments, the rail capacitor can also be leveraged for charging purposes. In this regard, the voltage source 705 can be a charging apparatus that is connected across the terminals of the rail capacitor 230. The voltage source 705 can charge the rail capacitor to a desired level and, through use of the same switch operation scheme used for balancing, the rail capacitor 203 can perform charging. In some respects, the impedance balancing apparatus can treat the voltage source 705 as another cell or parallel group of cells for balancing. However, since the voltage source 705 is an entry point for energy into the system, the rail capacitor 230 would continuously be charged by the voltage source 705, until the voltage source 705 is removed from the circuit as the charger.

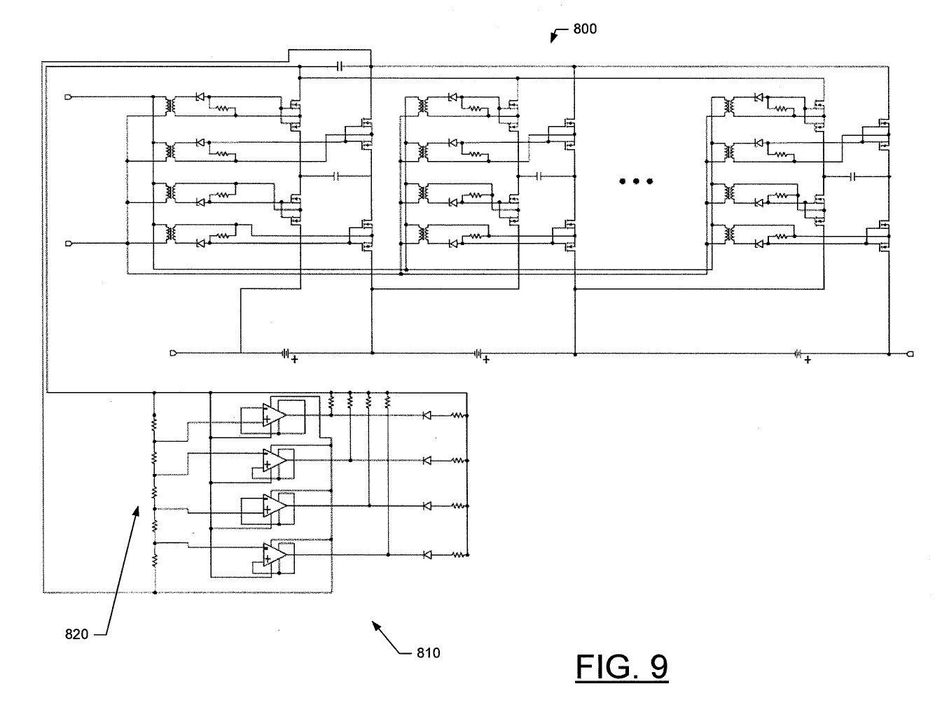

FIG. 9 illustrates another example embodiment of the present invention that includes an example impedance balancer 800 and an energy management system monitor 810. The impedance balancer 800 illustrates how any number of power cells or parallel groups of power cells can be connected to an impedance balancer. Further, the energy management system monitor 810 includes four comparators for indicating undervoltage, above low operating voltage, below maximum operating voltage, and overvoltage conditions. The inputs to the comparators can be taken from the resistor network 820, where the resistor values are selected based on the voltage threshold associated with the respective conditions. According to some example embodiments, such as, for example, micropower systems, the impedance balancer 800, the energy management system monitor 810, and other example embodiments described herein, can be partially or wholly implemented in a field programmable gate array (FPGA), application specific integrated circuit (ASIC), or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. An impedance balancer comprising:
a rail capacitor comprising rail capacitor terminals;
a first capacitor comprising first capacitor terminals, wherein the first capacitor terminals are switchably connected across terminals of a first power cell via a first set of controllable switches, and wherein the first capacitor terminals are also switchably connected across the rail capacitor terminals via a second set of controllable switches; and
a second capacitor comprising second capacitor terminals, wherein the second capacitor terminals are switchably connected across the rail capacitor terminals via a third set of controllable switches, and wherein the second capacitor terminals are also switchably connected across terminals of a second power cell via a fourth set of controllable switches.

2. The impedance balancer of claim 1 further comprising control signal circuitry configured to provide respective control signals to the first, second, third and forth sets of controllable switches.

3. The impedance balancer of claim 1 further comprising voltage monitoring circuitry configured to:
receive an indication of a voltage across the rail capacitor terminals; and
provide a status indicator for an energy system based on the received indication.

4. The impedance balancer of claim 1 further comprising voltage monitoring circuitry configured to:
compare an indication of a voltage across the rail capacitor terminals to an overvoltage reference to determine an overvoltage status of an energy system; and
compare an indication of a voltage across the rail capacitor terminals to an undervoltage reference to determine an undervoltage status of the energy system.

5. The impedance balancer of claim 1, wherein the first power cell is electrically connected in parallel with at least a third power cell, and wherein the second power cell is electrically connected in parallel with at least a fourth power cell.

6. The impedance balancer of claim 1 further comprising control signal circuitry configured to provide respective control signals to each switch within the first and second sets of controllable switches, wherein the respective control signals are configured to:
cause the first set of controllable switches to generate an electrical connection between the first capacitor terminals and the terminals of the first power cell to charge or discharge the first capacitor across the terminals of the first power cell; and
cause the second set of controllable switches to generate an electrical connection between the first capacitor terminals and the rail capacitor terminals to charge or discharge the first capacitor across the terminals of the rail capacitor.

7. The impedance balancer of claim 1 further comprising control signal circuitry configured to provide a first set of control signals to the second set of controllable switches and a second set of control signals to the third set of controllable switches;
wherein the first set of control signals cause the second set of controllable switches to generate and break an electrical connection between the first capacitor terminals and the rail capacitor terminals based on a frequency of the first set of control signals; and
wherein the second set of control signals cause the third set of controllable switches to generate and break an electrical connection between the rail capacitor terminals and the second capacitor terminals based on a frequency of the second set of control signals

8. The impedance balancer of claim 1 further comprising control signal circuitry configured to provide a first set of control signals to the first set of controllable switches and a second set of control signals to the second set of controllable switches, wherein respective frequencies of the first set of control signals and the second set of control signals are based on an output current of an energy system comprising the first power cell and the second power cell.

9. The impedance balancer of claim 1 further comprising control signal circuitry configured to provide respective control signals to each of the switches within the first, second, third, and forth sets of controllable switches, wherein the respective control signals are configured to:
cause the first set of controllable switches to generate an electrical connection between the first capacitor terminals and the terminals of the first power cell to charge or discharge the first capacitor across the terminals of the first power cell;
cause the second set of controllable switches to generate an electrical connection between the first capacitor terminals and the rail capacitor terminals to charge or discharge the first capacitor across the terminals of the rail capacitor;
cause the third set of controllable switches to generate an electrical connection between the rail capacitor terminals and the second capacitor terminals to charge or discharge the second capacitor across the rail capacitor terminals; and
cause the fourth set of controllable switches to generate an electrical connection between the second capacitor terminals and the terminals of the second power cell to charge or discharge the second capacitor across the terminals of the second power cell;
wherein the first and fourth sets of controllable switches do not generate electrical connections simultaneously.

10. The impedance balancer of claim 1 further comprising control signal circuitry configured to provide respective control signals to each of the switches within the first, second, third, and forth sets of controllable switches, wherein the respective control signals are configured to control the second and third sets of controllable switches to prevent the rail capacitor terminals from being electrically connected to the first capacitor terminals and the second capacitor terminals simultaneously.

11. The impedance balancer of claim 1, wherein at least the controllable switches within the first, second, third, and fourth sets of controllable switches is a transistor, and wherein a gate terminal of the transistor is driven by a control signal provided via a terminal of a transformer.

12. The impedance balancer of claim 1, wherein at least the controllable switches within the first, second, third, and fourth sets of controllable switches is a transistor, and wherein a gate terminal of the transistor is driven by a control signal provided via a terminal of a transformer, a waveform of the control signal being modified by a shunt resistor and a diode connected across the secondary terminals of the transformer.

13. A method for performing power cell balancing, the method comprising:
generating an electrical connection between terminals of a first capacitor and terminals of a first power cell to charge or discharge the first capacitor across the terminals of the first power cell;
generating an electrical connection between the terminals of the first capacitor and terminals of a rail capacitor to charge or discharge the first capacitor across the terminals of the rail capacitor;
generating an electrical connection between the terminals of the rail capacitor and terminals of a second capacitor to charge or discharge the second capacitor across the rail capacitor terminals; and
generating an electrical connection between the terminals of the second capacitor and terminals of a second power cell to charge or discharge the second capacitor across terminals of a second power cell.

14. The method of claim 13 further comprising:
receiving control signals at a first set of controllable switches to generate the electrical connection between the terminals of the first capacitor and the terminals of the first power cell;
receiving control signals at a second set of controllable switches to generate the electrical connection between the terminals of the first capacitor and the terminals of a rail capacitor;
receiving control signals at a third set of controllable switches to generate the electrical connection between the terminals of the rail capacitor and the terminals of the second capacitor; and
receiving control signals at a fourth set of controllable switches to generate the electrical connection between the terminals of the second capacitor and the terminals of the second power cell.

15. The method of claim 13 further comprising:
receiving an indication of a voltage across the terminals of the rail capacitor; and
providing a status indicator for an energy system based on the received indication.

16. The method of claim 13 further comprising:
comparing an indication of a voltage across the terminals of the rail capacitor to an overvoltage reference to determine an overvoltage status of an energy system; and
comparing an indication of a voltage across the terminals of the rail terminals to an undervoltage reference to determine an undervoltage status of the energy system.

17. The method of claim 13, wherein the first power cell is electrically connected in parallel with at least a third power cell, and wherein the second power cell is electrically connected in parallel with at least a fourth power cell.

18. The method of claim 13, further comprising:
generating and breaking the electrical connection between the terminals of the first capacitor and terminals of a rail capacitor based on a frequency of a first set of control signals; and
generating and breaking the electrical connection between the terminals of the rail capacitor and the terminals of a second capacitor based on a frequency of a second set of signals;
wherein the first set of control signals and second set of control signal are further configured to prevent the rail capacitor terminals from being electrically connected to the first capacitor terminals and the second capacitor terminals simultaneously.

19. The method of claim 13, further comprising:
generating and breaking the electrical connection between the terminals of the first capacitor and terminals of a rail capacitor based on a frequency of a first set of control signals; and
generating and breaking the electrical connection between the terminals of the rail capacitor and the terminals of a second capacitor based on a frequency of a second set of signals;
wherein respective frequencies of the first set of control signals and the second set of control signals are based on an output current of an energy system comprising the first power cell and the second power cell.

20. The method of claim 13, wherein at least one of generating the electrical connection between the terminals of the first capacitor and the terminals of a first power cell, generating the electrical connection between the terminals of the first capacitor and the terminals of the rail capacitor, generating the electrical connection between the terminals of the rail capacitor and the terminals of the second capacitor, or generating the electrical connection between the terminals of the second capacitor and terminals of the second power cell is performed by driving a gate terminal of a transistor via a terminal of a transformer.

21. The method of claim 13, wherein at least one of generating the electrical connection between the terminals of the first capacitor and the terminals of a first power cell, generating the electrical connection between the terminals of the first capacitor and the terminals of the rail capacitor, generating the electrical connection between the terminals of the rail capacitor and the terminals of the second capacitor, or generating the electrical connection between the terminals of the second capacitor and terminals of the second power cell is performed by driving a gate terminal of a transistor via a terminal of a transformer, a waveform of a signal provided to the gate terminal being modified by a shunt resistor and a diode connected across the terminals of the transformer.

22. An energy management system monitor comprising circuitry configured to measure a voltage across a rail capacitor and output a status indication based on the measured voltage, wherein the rail capacitor is switchably connected to a first capacitor and switchably connected to a second capacitor, and wherein the first capacitor is also switchably connected to a first power cell and the second capacitor is also switchably connected to a second power cell.

23. The energy management system monitor of claim 22, wherein the circuitry configured to output the status indication includes being configured to output a plurality of status indications by comparing the measured voltage to a respective plurality of reference voltages.
